(19) United States
(12) Patent Application Publication
(10) Pub. No.: US 2023/0286387 A1
(43) Pub. Date: Sep. 14, 2023

(54) CONTROL SYSTEM

(71) Applicant: J. C. Bamford Excavators Limited, Uttoxeter (GB)

(72) Inventor: Lee Harper, Uttoxeter (GB)

(73) Assignee: J. C. Bamford Excavators Limited, Uttoxeter (GB)

(21) Appl. No.: 18/116,842

(22) Filed: Mar. 3, 2023

(30) Foreign Application Priority Data
Mar. 14, 2022 (GB) 2203515.8

(51) Int. Cl. B60L 3/00; H02P 6/16; G10K 11/178

(52) U.S. Cl. CPC B60L 3/0084; B60L 3/003; G10K 11/1787; H02P 6/16; B60L 2210/40; B60L 2270/142; G10K 2210/128; H02P 2209/11

(57) ABSTRACT

A control system for an electric working vehicle includes a first component associated with a first rotor and a second component associated with a second rotor. In use, the first rotor is associated with a first noise waveform and the second rotor is associated with a second noise waveform. Furthermore, in use, the vehicle is associated with a resultant noise waveform comprising the first and second noise waveforms. The control system is configured to control an angular position of the first and/or second rotor such that a parameter associated with the resultant noise waveform is optimised. In this manner, the noise performance of the vehicle can be improved.

### FIELD

The present disclosure relates to a control system for an electric working vehicle and an electric vehicle comprising the control system.

### BACKGROUND

Electrically powered vehicles typically comprise multiple systems (such as hydraulic or cooling systems) which can be notoriously noisy during operation. Unlike in traditional diesel or petrol-powered vehicles, in electrically powered vehicles the noise created by such systems is not masked by the noise generated from the combustion engine.

As such, a challenge is presented to reduce the noise generated by electrically powered vehicles.

The present disclosure seeks to overcome, or at least mitigate, this problem.

### SUMMARY

According to a first aspect of the present disclosure, there is provided a control system for an electric working vehicle comprising a first component associated with a first rotor and a second component associated with a second rotor, wherein, in use, the first rotor is associated with a first noise waveform, the second rotor is associated with a second noise waveform, and the vehicle is associated with a resultant noise waveform comprising the first and second noise waveforms, and wherein the control system is configured to control an angular position of the first and/or second rotor such that a parameter associated with the resultant noise waveform is optimised.

Advantageously, by adjusting the angular position of the first and/or second rotors, the noise waveforms generated by said rotors can be manipulated help optimise the noise performance of the vehicle.

The term “N” is used herein to denote the number of components of a given electric vehicle.

In some embodiments, the vehicle comprises N number of components, wherein N is greater than 2, wherein each component is associated with a respective rotor and wherein each rotor is associated with a respective noise waveform when in use wherein the resultant noise waveform comprises each of the respective noise waveforms, and wherein the control system is configured to adjust the angular position of at least one of the rotors such that a parameter associated with the resultant noise waveform is optimised.

Advantageously, by adjusting the angular position of at least one of the rotors, the noise waveforms generated by said rotors can be manipulated help optimise the noise performance of the vehicle.

In some embodiments, the control system is configured to optimise the parameter with respect to a cab of the vehicle.

In some embodiments, the control system is configured to control an angular position of at least one of the rotors such that the parameter associated with the resultant noise waveform is minimised.

Advantageously, by adjusting the angular position of at least one of the rotors, the noise waveforms generated by said rotors can be manipulated to achieve a noise cancellation effect (due to destructive superposition), which helps to optimise the noise performance of the vehicle.

In some embodiments, the parameter is a maximum amplitude of the resultant noise waveform.

In some embodiments, the parameter is an average amplitude of the resultant noise waveform.

In some embodiments, the parameter is a maximum peak to trough distance.

In some embodiments, the parameter is an average peak to trough distance.

In some embodiments, the angular position of at least one of the rotors is controlled so as to maintain a desired phase offset between the noise waveforms associated with the respective rotors.

Advantageously, offsetting the phases of the waveforms associated with the respective rotors results in a cancellation effect due to destructive superposition which helps to optimise the noise performance of the vehicle.

In some embodiments, the vehicle comprises N number of components, wherein N is 2 or more, wherein each component is associated with a respective rotor and wherein each rotor is associated with a respective noise waveform when in use, and wherein the control system is configured to control the angular position of at least one of the rotors such that the noise waveforms associated with the rotors of the N components are approximately

$$\frac{360}{N}$$

degrees out of phase.

Advantageously, optimal noise cancelling performance can be achieved in vehicles using multi-rotor systems when the noise waveforms generated by the rotors are 360/N degrees out of phase.

In some embodiments, the control system is configured to control the angular position of at least one of the rotors by controlling an angular velocity of said rotor.

In some embodiments, the control system is configured to control an angular velocity of one or more of the rotors such that the frequencies of the noise waveforms associated with the respective rotors during use are controlled to optimise the parameter associated with the resultant noise waveform.

Advantageously, by adjusting the angular velocity of the at least one of the rotors, the noise waveforms generated by said rotors can be further manipulated help optimise the noise performance of the vehicle.

In some embodiments, the control system is configured to control the angular velocity of one or more of the rotors such that the frequencies of the waveforms associated with the respective rotors are substantially equal.

Advantageously, since the effects of destructive superposition are maximised when waveforms are of the same frequency, this helps to further enhance the noise cancellation achieved by the control system.

In some embodiments, the control system is configured to modulate the angular velocity of the rotors during use.

Advantageously, modulating the angular velocity of the rotors helps to prevent the noise waveforms generated by said rotors from resonating.

In some embodiments, the control system is configured to:
a) determine an angular position of each rotor;
b) determine an offset between the angular positions of the rotors; and
c) control the angular position of at least one of the rotors based on the determined offset in order to optimise the parameter of the resultant noise waveform.

Advantageously, by adjusting the angular position of at least one of the rotors, the noise waveforms generated by said rotors can be manipulated help optimise the noise performance of the vehicle.

In some embodiments, the control system is configured to carry out the process defined by steps a) to c) repeatedly at regular intervals.

In some embodiments, the control system is configured to control the angular position of at least one of the rotors when the determined offset differs from a target offset value by at least a predetermined amount.

Advantageously, offsetting the phases of the waveforms associated with the respective rotors results in a cancellation effect due to destructive superposition which helps to optimise the noise performance of the vehicle.

In some embodiments, the target offset value is

$$\frac{360}{N}$$

degrees.

Advantageously, optimal noise cancelling performance can be achieved in vehicles using multi-rotor systems when the noise waveforms generated by the rotors are 360/N degrees out of phase.

In some embodiments, the control system is configured to:
a) obtain a resultant noise waveform of the electric vehicle at a time tₙ; and
b) control the angular position of at least one of the rotors.

In some embodiments, the control system is further configured to:
c) after step b), obtain an updated resultant noise waveform of the electric vehicle at a time tₙ₊₁;
d) compare the resultant noise waveform at time tₙ to the resultant noise waveform at time tₙ₊₁; and
e) control the angular position of at least one of the rotors based on the comparison carried out during step d) to optimise the parameter of the resultant noise waveform of the electric vehicle.

Advantageously, this feature enables the noise generated by the electric vehicle to be reduced without needing to know the exact positions of the rotor. Furthermore, in systems where the position of the rotors is measured, this can help to further improve the effectiveness of the system.

In some embodiments, the control system is configured to control the relative angular position of at least one of the rotors when the parameter of the resultant noise waveform differs from a desired target value by at least a predetermined amount.

According to a second aspect of the present disclosure, there is provided an electric vehicle comprising a first component associated with a first rotor which is associated with a first waveform when in use; a second component associated with a second rotor which is associated with a second waveform when in use; and the control system according to the first aspect of the present disclosure wherein the vehicle is associated with a resultant noise waveform comprising the first and second noise waveforms, when in use.

In some embodiments, the electric vehicle comprises N number of components, wherein N is greater than 2, and wherein each component is associated with a respective rotor which is associated with a respective noise waveform when in use, and wherein the resultant noise waveform comprises each of the respective noise waveforms.

In some embodiments, the electric vehicle further comprises a plurality of electric motors, each configured to actuate a respective one of the rotors and at least one inverter configured to control a speed of at least one of the plurality of electric motors.

In some embodiments, the electric vehicle comprises a plurality of inverters, each being configured to control a respective speed of one of the plurality of electric motors.

In some embodiments, the control system is configured to control an angular position and/or an angular velocity of at least one of the rotors by controlling a motor operating target speed supplied to the at least one inverter associated with said rotor.

In some embodiments, the control system is configured to modulate the angular velocity of at least one of the rotors via the at least one inverter during use.

Advantageously, modulating the angular velocity of the rotors helps to prevent the sound waves generated by said rotors from resonating.

In some embodiments, the vehicle further comprises at least one position sensor configured to measure an angular position of each rotor. It will be appreciated that any suitable angular or position sensor/encoder may be used.

In some embodiments, the control system is configured to determine the angular position of each rotor based on the measurements provided by the at least one position sensor.

In some embodiments, the at least one position sensor is a motor position sensor configured to determine the position of the one or more rotors based on the position of the corresponding electric motor.

Advantageously, this feature avoids the need for placing sensors about the rotors (also known as “sensorless” operation)

In some embodiments, the electric vehicle further comprises a transducer (e.g., a microphone) configured to measure a vibration signature of the electric vehicle.

In some embodiments, the control system is configured to obtain the resultant noise waveform for the electric vehicle based on the vibration signature obtained by the transducer.

Advantageously, this feature enables the noise generated by the electric vehicle to be deduced without needing to know the exact positions of the rotors.

In some embodiments, the electric vehicle comprises a cooling system (e.g., a cooling fan) comprising the first component and/or the second component and/or the Nth component.

In some embodiments, the electric vehicle comprises a hydraulic system (e.g., a hydraulic pump) comprising the first component and/or the second component and/or the Nth component.

In some embodiments, the electric vehicle comprises a traction system (e.g., a traction motor) comprising the first component and/or the second component and/or the Nth component.

In some embodiments, the electric vehicle is a working vehicle.

In some embodiments, the electric vehicle is an off-highway vehicle.

In some embodiments, the electric vehicle is a land vehicle.

### BRIEF DESCRIPTION OF THE DRAWINGS

The present disclosure will now be described, by way of example only, with reference to the following figures in which:

FIG. 1 is a schematic illustration of an embodiment of an electric working vehicle disclosed herein;

FIG. 2 is a schematic illustration of a control system as disclosed herein, along with various components of the electric working vehicle illustrated in FIG. 1;

FIG. 3 is a flow diagram illustrating the basic principles of operation of the control system illustrated in FIG. 2;

FIG. 4 is a flow diagram illustrating the operation of the control system illustrated in FIGS. 2 and 3; and

FIG. 5 is a flow diagram illustrating the operation of a control system according to another embodiment of the present disclosure.

### DETAILED DESCRIPTION

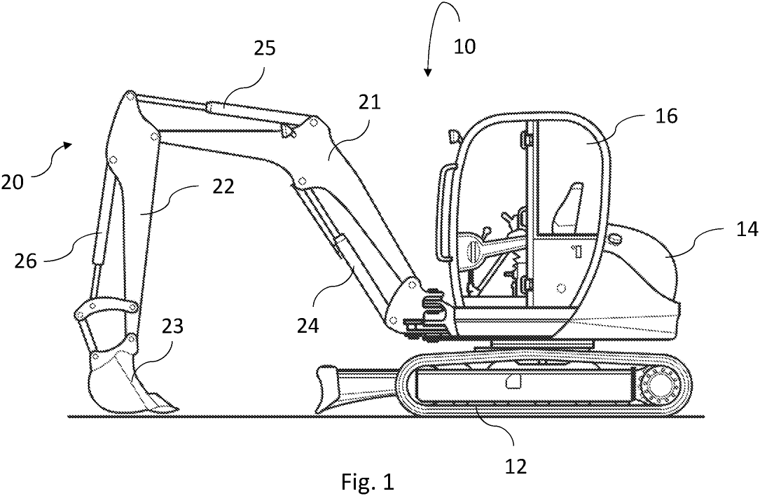

Referring to FIG. 1, an electric vehicle according to an embodiment of the present disclosure is indicated at 10.

In the embodiment illustrated in FIG. 1, the electric vehicle is an electric working vehicle. However, it shall be appreciated that in other embodiments, the electric vehicle may be of any suitable kind including, but not limited to, a car, a motorcycle, a utility vehicle, a van, a light truck, a heavy goods vehicle, a recreational vehicle, an all-terrain vehicle etc.

A working vehicle is an off-highway vehicle, for example those used in construction industries (e.g., backhoe loaders, excavators, slew excavators, telescopic handlers, forklifts, skid-steer loaders, dump trucks, bulldozers, graders), agricultural industries (e.g., tractors, combine harvesters, self-propelled harvesters, and sprayers), quarrying (e.g., loading shovels, aggregate crushing equipment), and forestry (e.g., timber harvesters, feller bunchers).

In the illustrated embodiment, the working vehicle 10 is a crawler excavator having a chassis 14 and a ground engaging transport means in the form of a pair of tracks 12 provided on the chassis 14 to move the vehicle 10 over the ground. However, in alternative embodiments, other ground engaging means can be provided, for example wheels may be provided to move the working vehicle 10, instead of tracks 12.

An arm assembly is coupled to the chassis 14 and includes a working arm 20 which is pivotally coupled to the chassis 14.

The working vehicle 10 also includes a cab 16 with a collection of controls (not shown) for moving the working arm 20, manoeuvring the working vehicle 10 and/or controlling other functions of the working vehicle 10.

The working arm 20 includes a boom 21 pivotally attached to the front of the chassis 14. The working arm 20 also includes a dipper arm 22 pivotally attached to the boom and an implement 23 pivotally attached to the dipper arm 22 (i.e., connected to a free end of the working arm 20). In some embodiments, the implement may be a bucket, which is used for soil-shifting or materials handling operations (e.g., trenching, grading, and loading) and/or materials handling (e.g., depositing aggregate in trenches, lifting materials, and placing them on an elevated platform).

In alternative embodiments, an alternative implement may be used, such as a hydraulic hammer drill. A hydraulic hammer drill includes a drill bit configured for reciprocating movement under the action of pressurized hydraulic fluid (e.g., hydraulic fluid supplied via an auxiliary hose of a hydraulic system of the working vehicle 10). Such a hydraulic hammer drill is typically used for breaking apart materials (e.g., a concrete/tarmac road surface).

Furthermore, in some embodiments, the working arm may be a triple-articulated boom (or TAB boom) comprising a boom and a plurality of dipper arm sections pivotally attached between the boom and the implement. Advantageously, the use of a TAB boom can help to improve the flexibility and versatility of the working arm.

A boom actuator 24 is provided to move the boom in an ascending direction and a descending direction. The boom actuator is provided in the form of a boom actuator body defining a bore, a piston configured for reciprocating movement within the bore, and a rod connected to the piston and extending through the boom actuator body. The working vehicle 10 also includes a dipper actuator 25 similar to the boom actuator 24, for pivoting the dipper arm 22 with respect to the boom 21, and an implement actuator 26 similar to the boom actuator 24, for pivoting the implement 23 with respect to the dipper arm 22. The working vehicle 10 also includes a hydraulic system (not shown) for controlling the boom actuator, dipper actuator, bucket actuator and other hydraulic functions of the working vehicle 10.

In the illustrated embodiment, the electric working vehicle is a hydrogen-powered working vehicle. The chassis 14 of the electric vehicle 10 houses a hydrogen fuel cell (not shown) comprising an anode (not shown) and a cathode (not shown). During use, hydrogen fuel from a hydrogen storage unit (not shown) is supplied to the anode of the hydrogen fuel cell and air (or another suitable substance) is supplied to the cathode via a suitable intake (not shown). The flow of electricity generated by the fuel cell can be subsequently used to power various components of the working vehicle 10 and/or can be passed to an energy storage device (such as a battery) via a suitable conduit (not shown) to be used to power components of the working vehicle at a later date.

The means by which a hydrogen fuel cell generates electricity is well known in the art and is not central to the concept of the present disclosure. As such, for conciseness, the operation of the hydrogen fuel cell will not be discussed in detail. Furthermore, in other embodiments, it shall be appreciated that other kinds of electric vehicle may be used, such as battery powered vehicles, and so the present disclosure is not solely limited to hydrogen-powered vehicles.

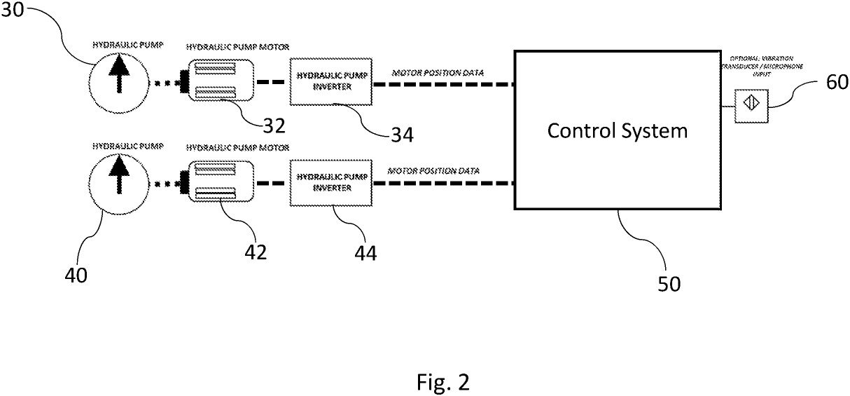

Referring now to FIG. 2, the electric vehicle 10 comprises two components 30, 40 for performing one or more functions during use.

In the illustrated embodiment, the first 30 and second 40 components are hydraulic pumps configured to actuate one or more hydraulic systems present on the vehicle 10. However, it shall be appreciated that in other embodiments, the first and/or second components may be another suitable component such as another component of the vehicle’s hydraulic system, a component of the vehicle’s traction system (e.g. a traction motor); a component of the vehicles cooling system (e.g. a cooling fan) or a combination thereof. Furthermore, whilst the electric vehicle illustrated in FIG. 2 comprises two components, in other embodiments, the number of components (N) may be greater than two.

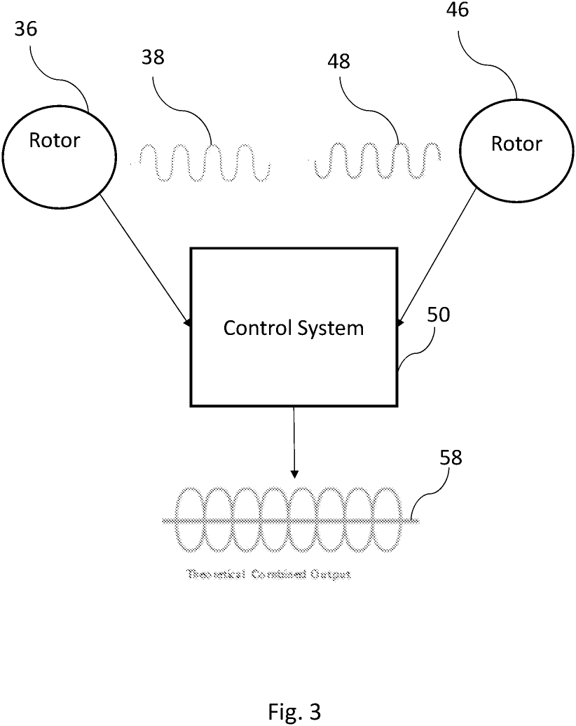

The first 30 and second 40 components are each associated with a respective rotor 36, 46 (shown schematically in FIG. 3) which is driven (or actuated) by a corresponding electric motor 32, 42 via a suitable linkage or drivetrain. The rotors with which the first 30 and second 40 components are associated may comprise part of the first or second components (e.g., a fan blade) or may comprise part of the corresponding electric motor 32, 42 (e.g., the motor armature).

The electric vehicle 10 further comprises at least one inverter configured to regulate the flow of electrical power from the power supply (e.g., the battery or the hydrogen fuel cell) to a corresponding motor 32, 42, thereby enabling the speed of said motor to be controlled.

In the illustrated embodiment, a plurality of inverters 34, 44 are provided, with each being configured regulate the flow of electrical power to a respective one of the corresponding electric motors 32, 42. However, it shall be appreciated that in other embodiments, a single inverter may be provided with the remaining “inverter-less” motor being left to operate at a constant speed.

Referring now to FIG. 3, during operation, each rotor 36, 46 is associated with a corresponding noise waveform 38, 48 which is generated during operation. In traditional combustion-powered vehicles, the noise waveforms 38, 48 generated by each rotor 36, 46 would be masked by the noise of the combustion engine. However, in electric vehicles, the noise waveforms 38, 48 associated with each rotor 36, 46 cannot be masked in this manner and can therefore be noisy during operation.

The present disclosure addresses this problem by providing a control system 50 which is configured to control the angular position of the first 36 and/or second 46 rotor such that the resultant noise waveform 58 (which is the combined net waveform resulting from the first 38 and second 48 waveforms) is optimised.

The control system is configured to optimise one or more parameters of the noise waveform, such as a maximum amplitude of the resultant waveform; an average amplitude of the resultant waveform; a maximum peak to trough distance; and/or an average peak to trough distance.

In the embodiment illustrated in FIG. 3, the control system 50 is configured to control the angular position of the first 36 and/or second 46 rotors such that the noise waveforms associated with the first and second rotors are 180 degrees out of phase. Furthermore, the control system 50 is also configured to control the angular velocity of the first 36 and/or second 46 rotors such that the frequencies of the associated waveforms 38, 48 are substantially equal.

As can be seen in FIG. 3, under the above conditions, the first 38 and second 48 noise waveforms are in anti-phase which causes the average and maximum amplitude of the resultant noise waveform 58 to be zero. In other words, the noise generated by one rotor cancels out the noise generated by the other. In this manner, the noise generated by the components of the electric vehicle can be optimised.

However, it shall be appreciated that in some applications, it may not be practical to control the speed of two separate components such that the noise waveforms exhibit the same frequency due to other factors such as operational requirements. As such, optimal noise performance for a given application may be achieved at instances where the resultant noise waveform is not zero.

Furthermore, in vehicles where the number of components is greater than two, optimal noise cancellation performance may be found at different offsets. Typically, optimal noise cancellation performance is achieved when the associated waveforms are

$$\frac{360}{N}$$

degrees out of phase (where N is the number of components).

In some embodiments, the control system 50 can be further configured to modulate an angular velocity of the first 36 and/or second 46 rotors via periodically altering a motor operating target speed supplied to the associated inverter to help prevent the noise waveforms 38, 48 associated with the first 36 and second 46 rotors from resonating during operation.

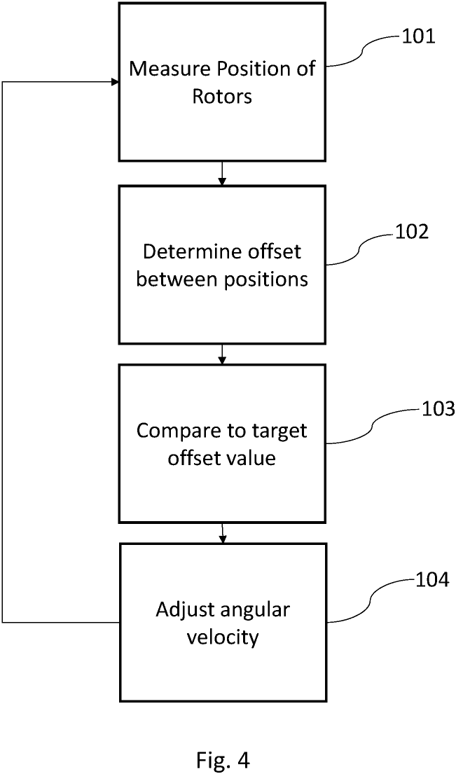

The operation of a control system according to an aspect of the present disclosure shall now be described with reference to FIG. 4.

In the embodiment illustrated in FIG. 4, the electric vehicle 10 comprises a pair of position sensors (not shown) each configured to measure an angular position of a respective rotor 36, 46.

In the illustrated embodiment, position sensors are provided in the form of motor position sensors, with each sensor being associated with a respective motor 32, 42 of the electric vehicle. The motor position sensors are each configured to determine the angular position of a given rotor based on the position of the electric motor associated with said rotor. This method is often known as “sensorless” operation and is advantageous since it does not require the placement of sensors about the rotors of the electric vehicle. However, it shall be appreciated that in other embodiments, other suitable types of position sensor (e.g., proximity sensors) may be used.

During step 101, the position sensors obtain position data corresponding to the first 36 and second 46 rotors (as shown in FIG. 2) and feed this information back to the control system 50.

During step 102, the control system 50 receives the position data provided by the position sensors and uses this data to determine the angular position of each rotor at a given period in time and the relative offset between the angular positions of the rotors 36, 46.

The control system 50 illustrated in FIG. 4 assumes that the position of each rotor corresponds to the noise waveform 38, 48 associated with said rotor. For example, when the rotor 36, 46 is at a 12 o′clock (or 0 degree) position, the associated sinusoidal noise waveform 38, 48 is also at an amplitude of zero. When the rotor 36, 46 is at a 3 o′clock (or 90 degree) position, the associated sinusoidal noise waveform 38, 48 reaches a peak or trough. When the rotor 36, 46 is at a 6 o′clock (or 180 degree) position, the associated sinusoidal noise waveform 38, 48 returns to zero and when the rotor 36, 46 is at a 9 o′clock (or 270 degree) position, the associated sinusoidal noise waveform 38, 48 reaches a peak or trough, and so on.

At step 103, the control system compares the offset value determined during step 102 to a target offset value set in advance. Typically, the offset target value is

$$\frac{360}{N}$$

degrees wherein N is the number of components. For example, the offset target value for a two- rotor system would typically be 180 degrees, the offset target value for a three-rotor system would typically be 120 degrees and so on.

If, during step 103, the control system 50 determines that the actual offset of the first 36 and second 46 rotors differs from the offset target value by at least a predetermined amount, a further control step 104 is performed.

At step 104, the control system 50 alters a motor operating target speed supplied to one or more of the associated inverters 34, 44. In turn, the inverter (or inverters) to which the altered motor operating target speed is supplied will alter the amount of electric power supplied to the first and/or second electric motors 32, 42. This will, in turn, enact a change in the motor operating speed of the motor 32, 42 associated with said inverter 34, 44 which will, in turn, increase or decrease the angular velocity of the rotor 36, 46 associated with said motor 32, 42.

In this manner, the relative angular velocities (and hence the relative angular positions) of the first 36 and second 46 rotors can be adjusted to achieve the desired offset. In embodiments where the first 36 and second 46 rotors can be operated at the same frequency, the motor operating target speed supplied to the associated inverters 34, 44 can then be further adjusted to ensure that the first 36 and second 46 rotors are operating at the same frequency once the desire amount of offset has been achieved.

Steps 101 to 104 can also be periodically repeated during operation of the electric vehicle to help ensure that the desired offset between rotors 36, 46 is maintained. In some embodiments the control system 50 may repeat steps 101 to 104 until the offset target value is reached. In other embodiments, steps 101 to 104 may be repeated until the determined offset of the first and second rotors is within the predetermined amount defined above.

Advantageously, the control system 50 described with reference to FIG. 4 provides an effective means for optimising noise performance of an electric vehicle when the positions of the respective rotors 36, 46 are known.

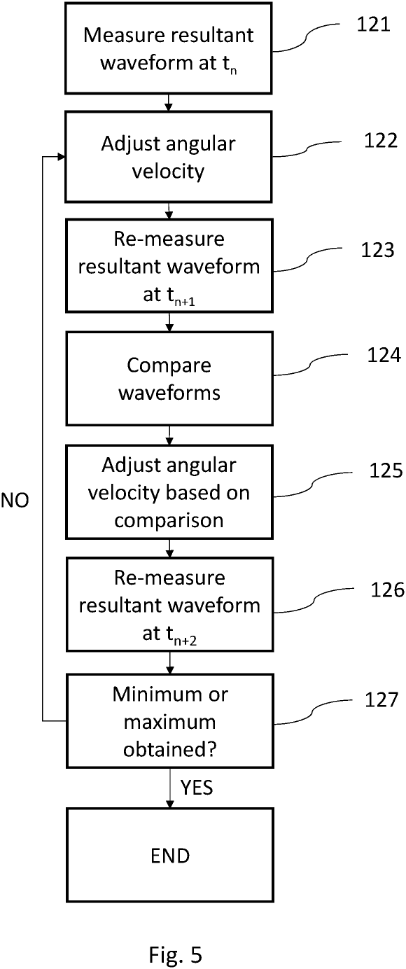

However, in some systems, it may not always be possible to obtain the exact position of each rotor during operation. To this end, the operation of a control system 150 according to another alternative embodiment of the present disclosure shall now be described with reference to FIG. 5. Unlike the control system 50 of FIG. 4, the control system 150 of FIG. 5 can be used even when the exact positions of each rotor are not known.

In the embodiment illustrated in FIG. 5, the electric vehicle 10 comprises a transducer 60 which is configured to measure a vibration signature of the electric vehicle 10. As shown in FIG. 2, the transducer 60 can be provided as an external microphone or vibration sensor, although it shall be appreciated that any other suitable transducer type may be used.

During step 121, a vibration signature is obtained by the transducer 60 at time tₙ. When this is the first vibration signature obtained, n=1. This signature is then passed to the control system 150. The control system 150 subsequently receives the vibration signature provided by the transducer 60 and uses said signature to determine the resultant waveform 58 of the first 36 and second 46 rotors at time tₙ. In some embodiments, the resultant waveform may be the vibration signature itself. In other embodiments, the vibration signature is processed to obtain the resultant waveform.

At step 122, the control system 150 adjusts the relative angular velocities of the first 36 and second 46 rotors in the same manner as set out above with reference to FIG. 4. In other words, the control system 150 alters a motor operating target speed supplied to one or more of the associated inverters 34, 44. In turn, the inverter (or inverters) to which the altered motor operating target speed is supplied will alter the amount of electric power supplied to the first and/or second electric motors 32, 42. This will, in turn, enact a change in the motor operating speed of the motor associated with said inverter 34, 44 which will, in turn, increase or decrease the angular velocity of the rotor 36, 46 associated with said motor 32, 42. In this way, the relative angular positions of the rotors 36, 46 is adjusted.

Once the angular position of at least one of the rotors 36, 46 has been adjusted, the vibration signature is re-measured by the transducer 60 at time tₙ₊₁, where the previous measurement was taken at time tₙ (see step 123). It will be appreciated that n may be any integer number. The vibration signature obtained by the transducer 60 at time tₙ₊₁ is then passed to the control system 150.

The control system 150 subsequently receives the vibration signature provided by the transducer 60 and determines the resultant waveform 58 at time tₙ₊₁.

At step 124, the control system 150 compares the resultant noise waveform obtained at time tₙ to the resultant noise waveform obtained at time tₙ₊₁ to determine whether the parameter has been improved or worsened by the adjustment of the relative rotor positions.

A further adjustment of the relative angular velocities of the first 36 and second 46 rotors is then performed during step 125 based on the results of the comparison performed during step 124, in the same manner as had been described for step 122 above.

For example, if the control system 150 determines at step 124 that a parameter of the resultant noise waveform 58 has been improved by increasing the angular velocity of one of the rotors during step 122, during step 125 the control system 150 may further increase the angular velocity of said rotor in the expectation that such an adjustment will help to further optimise a parameter of the resultant noise waveform 58.

Conversely, if during the comparison performed at step 124 it is determined that increasing the angular velocity of one of the rotors during step 122 has an adverse effect on the desired parameter, the adjustment performed at step 125 may instead decrease the angular velocity of said rotor, e.g., to return the system to its previous state.

In the illustrated embodiment, following step 125 the resultant waveform is re-measured at time tₙ₊₂ (see step 126) and at step 127 it is determined whether a minimum or maximum of the noise parameter has been obtained. If (at step 127) it is determined that a minimum or maximum of the noise parameter has not been obtained, steps 122 to 127 are then repeated to incrementally optimise the noise performance of the electric vehicle 10 (i.e. the measurement at tₙ₊₂ is taken to be tₙ). As such, the control system 150 illustrated in FIG. 5 provides an effective iterative feedback loop which enables the noise performance of the electric vehicle to be incrementally optimised without needing to measure the exact positions of each rotor. In the illustrated embodiment, steps 122 to 127 continue to be repeated until a minimum or maximum of the noise parameter is obtained.

In some embodiments, rather that repeating steps 122 to 127 until a minimum or maximum is reached, steps 121 to 125 may instead be periodically repeated at regular intervals. In such embodiments, steps 126 and 127 may be omitted. Furthermore, in some embodiments, steps 121 to 125 may be periodically repeated at regular intervals even after a minimum or maximum of the noise parameter has been obtained at step 127 to help ensure that the desired noise performance is being maintained during operation.

Furthermore, in some embodiments the magnitude of the angular velocity adjustment may be varied based on the number of iterations and/or based on how close the noise parameter is to a maximum or minimum value. For example, the adjustments will typically be smaller in magnitude when the noise parameter is close to a minimum or maximum value.

It shall also be appreciated that the control systems of FIG. 4 and FIG. 5 may be used in combination to help further improve the effectiveness of the system.

In the illustrated embodiments, the control system is configured to optimise a parameter associated with the resultant waveform with respect to a user located within a cab of the electric vehicle. However, it shall be appreciated that in other embodiments, the control system may alternatively be configured to optimise a parameter associated with the resultant waveform with respect to a bystander, particularly in applications where vehicles are required to meet certain noise emission standards.

Furthermore, whilst the embodiments described above are illustrated as two-rotor systems, it shall be appreciated that in other embodiments, the control system (and associated methods of operation) may be used with electric vehicles having N number of components, wherein N is greater than 2.

Although the invention has been described in relation to one or more embodiments, it will be appreciated that various changes or modifications can be made without departing from the scope of the invention as defined in the appended claims.

It should also be noted that whilst the appended claims set out particular combinations of features described above, the scope of the present disclosure is not limited to the particular combinations hereafter claimed, but instead extends to encompass any combination of features herein disclosed.

1. A control system for an electric working vehicle comprising a first component associated with a first rotor and a second component associated with a second rotor, wherein, in use, the first rotor is associated with a first noise waveform, the second rotor is associated with a second noise waveform, and the vehicle is associated with a resultant noise waveform comprising the first and second noise waveforms, and wherein the control system is configured to control an angular position of the first and/or second rotor such that a parameter associated with the resultant noise waveform is optimised.

2. The control system according to claim 1, wherein the vehicle comprises N number of components, wherein N is greater than 2, wherein each component is associated with a respective rotor and wherein each rotor is associated with a respective noise waveform when in use, wherein the resultant noise waveform comprises each of the respective noise waveforms, and wherein the control system is configured to adjust the angular position of at least one of the rotors such that a parameter associated with the resultant noise waveform is optimised.

3. The control system according to claim 1, wherein the control system is configured to control an angular position of at least one of the rotors such that the parameter associated with the resultant noise waveform is minimised.

4. The control system according to claim 3, wherein the parameter comprises at least one of:
a maximum amplitude of the resultant noise waveform;
an average amplitude of the resultant noise waveform;
a maximum peak to trough distance; and/or
an average peak to trough distance.

5. The control system according to claim 1, wherein the angular position of at least one of the rotors is controlled so as to maintain a desired phase offset between the noise waveforms associated with the respective rotors, and optionally wherein the vehicle comprises N number of components, wherein N is 2 or more, wherein each component is associated with a respective rotor and wherein each rotor is associated with a respective noise waveform when in use, and wherein the control system is configured to control the angular position of at least one of the rotors such that the noise waveforms associated with the rotors of the N components are approximately
$$\frac{360}{N}$$
degrees out of phase.

6. The control system according to claim 1, wherein the control system is configured to control the angular position of at least one of the rotors by controlling an angular velocity of said rotor.

7. The control system according to claim 1, wherein the control system is configured to control an angular velocity of one or more of the rotors such that the frequencies of the noise waveforms associated with the respective rotors during use are controlled to optimise the parameter associated with the resultant noise waveform, and optionally wherein the control system is configured to control the angular velocity of one or more of the rotors such that the frequencies of the waveforms associated with the respective rotors are substantially equal.

8. The control system according to claim 1, wherein the control system is configured to:
a) determine an angular position of each rotor;
b) determine an offset between the angular positions of the rotors; and
c) control the angular position of at least one of the rotors based on the determined offset in order to optimise the parameter of the resultant noise waveform.

9. The control system according to claim 8, wherein the control system is configured to control the angular position of at least one of the rotors when the determined offset differs from a target offset value by at least a predetermined amount.

10. The control system according to claim 1, wherein the control system is configured to:
a) obtain a resultant noise waveform of the electric vehicle at a time tₙ; and
b) control the angular position of at least one of the rotors.
c) after step b), obtain an updated resultant noise waveform of the electric vehicle at a time tₙ+₁;
d) compare the resultant noise waveform at time tₙ to the resultant noise waveform at time tₙ+₁; and
e) control the angular position of at least one of the rotors based on the comparison carried out during step d) to optimise the parameter of the resultant noise waveform of the electric vehicle.

11. An electric vehicle comprising:
a first component associated with a first rotor which is associated with a first waveform when in use; and
a second component associated with a second rotor which is associated with a second waveform when in use,
wherein the vehicle is associated with a resultant noise waveform comprising the first and second noise waveforms, when in use, and
wherein the electric vehicle further comprises a control system configured to control an angular position of the first and/or second rotor such that a parameter associated with the resultant noise waveform is optimised.

12. The electric vehicle according to claim 11, wherein the electric vehicle comprises N number of components, wherein N is greater than 2, and wherein each component is associated with a respective rotor which is associated with a respective noise waveform when in use, and wherein the resultant noise waveform comprises each of the respective noise waveforms.

13. The electric vehicle according to claim 11, wherein the electric vehicle further comprises:
a plurality of electric motors, each configured to actuate a respective one of the rotors; and
at least one inverter configured to control a speed of at least one of the plurality of electric motors, and optionally
wherein the electric vehicle comprises a plurality of inverters, each being configured to control a respective speed of one of the plurality of electric motors.

14. The electric vehicle according to claim 13, wherein the control system is configured to control an angular position and/or an angular velocity of at least one of the rotors by controlling a motor operating target speed supplied to the at least one inverter associated with said rotor.

15. The electric vehicle according to claim 13, wherein the control system is configured to modulate the angular velocity of at least one of the rotors via the at least one inverter during use.

16. The electric vehicle according to claim 11, wherein the vehicle further comprises at least one position sensor configured to measure an angular position of each rotor, and wherein the control system is configured to determine the angular position of each rotor based on the measurements provided by the at least one position sensor, and optionally wherein the at least one position sensor is a motor position sensor configured to determine the position of the one or more rotors based on the position of the or a corresponding electric motor.

17. The electric vehicle according to claim 11,
wherein the electric vehicle further comprises a transducer (e.g., a microphone) configured to measure a vibration signature of the electric vehicle; and
wherein the control system is configured to obtain the resultant noise waveform for the electric vehicle based on the vibration signature obtained by the transducer.

18. The electric vehicle according to claim 11, comprising a cooling system (e.g., a cooling fan); a hydraulic system (e.g., a hydraulic pump); and/or a traction system (e.g., a traction motor) comprising the first component and/or second component and/or Nth component.

19. The electric vehicle according to claim 11, wherein the electric vehicle is a working vehicle.

20. The electric vehicle according to claim 11, wherein the electric vehicle is a land vehicle.
